(19) United States
(12) Patent Application Publication
(10) Pub. No.: US 2008/0278694 A1
(43) Pub. Date: Nov. 13, 2008

(54) COLOR WHEEL MODULE AND PROJECTION APPARATUS USING THE SAME

(75) Inventors: Shang-Hsuang Wu, Hsinchu (TW); Te-Tang Chen, Hsinchu (TW); Nien-Hui Hsu, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsinchu (TW)

(21) Appl. No.: 11/864,940

(22) Filed: Sep. 29, 2007

(30) Foreign Application Priority Data
May 8, 2007 (TW) 96116279

(51) Int. Cl. G03B 21/14; G02B 5/22

(52) U.S. Cl. 353/84; 359/892

(57) ABSTRACT

A color wheel module including a motor, a filter unit, and a magnetic sensor is provided. The motor has a rotating unit. An index mark is disposed on the rotating unit. The filter unit is connected to the rotating unit. The magnetic sensor is disposed adjacent to the motor. The magnetic sensor is adopted for sensing the change of the magnetic field caused by the index mark rotating with the rotating unit. Further, a projection apparatus with the color wheel module is provided.

### CROSS-REFERENCE TO RELATED APPLICATION

This application claims the priority benefit of Taiwan application serial no. 96116279, filed May 8, 2007. All disclosure of the Taiwan application is incorporated herein by reference.

### BACKGROUND OF THE INVENTION

1. Field of the Invention

The present invention relates to a display device and internal elements thereof. More particularly, the present invention relates to a projection apparatus and a color wheel module thereof.

2. Description of Related Art

Referring to FIGS. 1A and 1B, a conventional color wheel module 100 is applied to a projection apparatus (not shown). The color wheel module 100 includes a filter unit 110 and a motor 120. The motor 120 includes a rotating unit 122 and a bracket 124 wrapping the rotating unit 122. The filter unit 110 is fixed on the rotating unit 122. In addition, the filter unit 110 includes a plurality of filters in different colors, such as a red filter 112r, a green filter 112g, and a blue filter 112b.

A control unit (not shown) of the projection apparatus drives the motor 120 to drive the filter unit 110 to rotate, and with the rotation of the filter unit 110, a beam passing through the filter unit 110 is sequentially filtered into a red light beam, a green light beam, and a blue light beam. Further, the control unit controls a digital micro-mirror device (DMD) of the projection apparatus to show different states in accordance with the generation time of the red light beam, the green light beam, and the blue light beam, so as to respectively convert the red light beam, the green light beam, and the blue light beam into a red image light beam, a green image light beam, and a blue image light beam. Further, the projection lens of the projection apparatus projects these image light beams onto a screen (not shown), so as to form a full-color image on the screen.

In view of the above, as the DMD shows different states in accordance with the generation time of the red light beam, the green light beam, and the blue light beam, it is necessary for the control unit to precisely master the time that the beam passes through each filter. Therefore, in the conventional art, as shown in FIG. 1B, a magnet 130 is disposed on the rotating unit 122 and serve as an index mark, and a magnetic sensor 140 is disposed on the inner wall of the bracket 124. The magnetic sensor 140 is adopted for sensing the change of the magnetic field caused by the magnet 130 rotating with the rotating unit 122, and outputs a signal to the control unit according to the change of the magnetic field when the rotating unit 122 rotates a circle, such that the control unit calculates the time that the beam passes through each filter.

However, the magnetic sensor 140 is disposed inside the motor 120, so when the motor 120 or the magnetic sensor 140 is damaged, the two must be replaced at the same time, which raises the maintenance cost. In addition, as the magnet 130 should corresponds to a specific position (for example, the junction of the two filters) of the filter unit 110, and the magnetic sensor 140 and the magnet 130 of the conventional art are disposed inside the motor 120, the position of the magnet 130 cannot be seen. In order to reduce the position difference resulted from assembling the filter unit 110 on the motor 120, a positioning hole 114 and a positioning hole 126 are respectively disposed at the filter unit 110 and the motor 120, and a positioning pin 150 is used to penetrate the two positioning holes 114, 126. As the positioning holes 114 and 126 are respectively disposed at the filter unit 110 and the motor 120, the assembly structures of the filter unit 110 and the motor 120 are complicated, and the production cost of the color wheel module 100 is increased accordingly.

### SUMMARY OF THE INVENTION

Accordingly, the present invention is directed to a color wheel module which reduces the maintenance cost and the assembly complexity.

The present invention is also directed to a projection apparatus which reduces the maintenance cost and the assembly complexity of the color wheel module.

One embodiment of the present invention provides a color wheel module including a motor, a filter unit, and a magnetic sensor. The motor has a rotating unit, an index mark is disposed on the rotating unit, and the filter unit is connected to the rotating unit. The magnetic sensor is disposed adjacent to the motor, and the magnetic sensor is adopted for sensing the change of the magnetic field caused by the index mark rotating with the rotating unit.

Another embodiment of the present invention provides a projection apparatus including a light source, a display element, a control unit, a projection lens, and an aforementioned color wheel module. The light source is capable of providing an illumination beam, and the color wheel module is disposed on a transmission path of the illumination beam. The display element is disposed on a transmission path of the illumination beam after passing through the color wheel module, and the control unit is electrically connected to the motor, the magnetic sensor, and the display element. In addition, the control unit drives the motor, and controls the display element to convert the illumination beam into an image beam according to a received image signal and the signal output by the magnetic sensor. The projection lens is disposed on a transmission path of the image beam.

In the present invention, the magnetic sensor is disposed outside the motor, so when the motor or the magnetic sensor is damaged, it is only necessary to replace the damaged element, thus the maintenance cost is saved. In addition, the index mark and the magnetic sensor may be both outside the motor and it is unnecessary to additionally disposed a positioning mechanism on the filter unit and the motor. Therefore, the structures of the filter unit and the motor are simplified, and the production cost and the assembly complexity of the color wheel module are reduced.

Other features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a partial exploded view of a conventional color wheel module.

FIG. 1B is a schematic sectional view of a color wheel module of FIG. 1A.

FIG. 2 is a schematic view of a projection apparatus according to an embodiment of the present invention.

FIG. 3 is a schematic view of a color wheel module of FIG. 2.

FIG. 4 is a schematic view of a color wheel module according to another embodiment of the present invention.

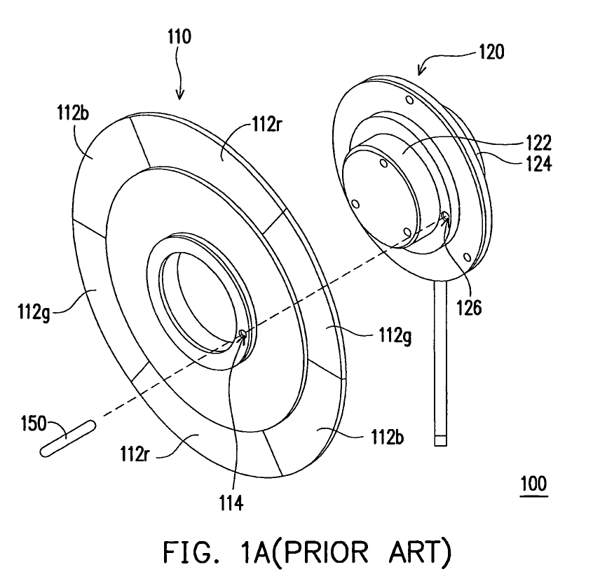

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and variations thereof herein are used broadly and encompass direct and indirect connections. Similarly, the terms “adjacent to” and variations thereof herein are used broadly and encompass directly and indirectly “adjacent to”. Therefore, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

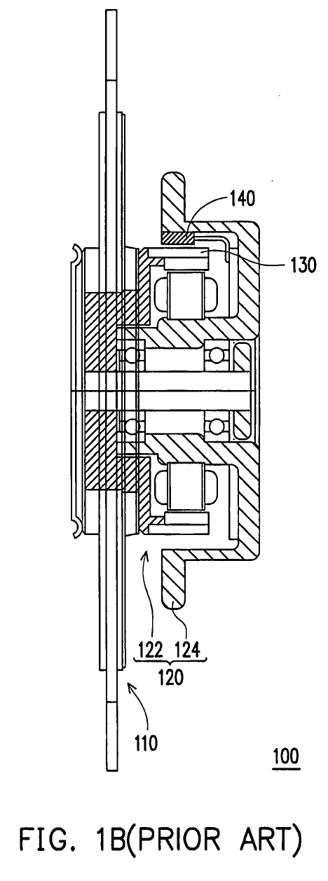

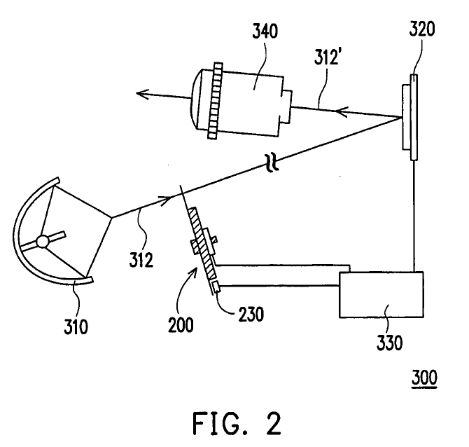

Referring to FIGS. 2 and 3, a projection apparatus 300 of an embodiment of the present invention includes a light source 310, a display element 320, a control unit 330, a projection lens 340, and a color wheel module 200. The light source 310 is capable of providing an illumination beam 312, and the color wheel module 200 is disposed on a transmission path of the illumination beam 312. The display element 320 is disposed on a transmission path of the illumination beam 312 after passing through the color wheel module 200, and the display element 320 is, for example, a DMD, which is not limited herein.

The display element 320 is capable of converting the illumination beam 312 into an image beam 312′. The projection lens 340 is disposed on a transmission path of the image beam 312′, and the projection lens 340 is capable of projecting the image beam 312′ onto a screen (not shown), so as to form an image on the screen.

In the projection apparatus 300, the color wheel module 200 includes a motor 210, a filter unit 220, and a magnetic sensor 230. The motor 210 has a rotating unit 212; an index mark 214 is disposed on the rotating unit 212, and the filter unit 220 is connected to the rotating unit 212. The magnetic sensor 230 is disposed adjacent to the motor 210, and the control unit 330 is electrically connected to the motor 210, the magnetic sensor 230, and the display element 320. In addition, the index mark 214 may be a magnetic element, for example, a magnet, or a magnetic sticker, etc., disposed on the rotating unit 212, or may be a recess or a protrusion located on the rotating unit 212. The magnetic sensor 230 is, for example, a Hall effect sensor.

In view of the above, the filter unit 220 includes a plurality of filters in different colors, such as a red filter 222r, a green filter 222g, and a blue filter 222b. The control unit 330 is capable of driving the rotating unit 212 of the motor 210 to rotate, so as to drive the filter unit 220 to rotate. In this manner, the illumination beam 312 passes through the red filter 222r, the green filter 222g, and the blue filter 222b in sequence, so as to generate a red light beam, a green light beam, and a blue light beam.

When the rotating unit 212 rotates, the index mark 214 rotates with the rotating unit 212, and the magnetic sensor 230 is adopted for sensing the change of the magnetic field caused by the index mark 214 rotating with the rotating unit 212, so as to output a signal to the control unit 330 according to the rotation of the rotating unit 212. Particularly, the magnetic sensor 230, for example, outputs a signal to the control unit 330 when the rotating unit 212 rotates a circle, but it is not limited herein.

In addition, the control unit 330 calculates the generation time of the red light beam, the green light beam, and the blue light beam according to the received signal, and controls the display element 320 according to a received image signal, so as to make the display element 320 show different states, and to respectively convert the red light beam, the green light beam, and the blue light beam into a red image light beam, a green image light beam, and a blue image light beam. In other words, the image beam 312′ includes the red image light beam, the green image light beam, and the blue image light beam, and the projection lens 340 can project these image light beams onto the screen, so as to form a full-color image corresponding to the image signal on the screen. Further, the image signal is, for example, provided by a video player or a computer.

In this embodiment, the magnetic sensor 230 is disposed adjacent to the motor 210, instead of inside the motor 210, so when the motor 210 or the magnetic sensor 230 is damaged, it is only necessary to replace the damaged element. Compared with the conventional art that the motor and the magnetic sensor should be replaced together, the color wheel module 200 of this embodiment is lower in maintenance cost.

Further, the index mark 214 and the magnetic sensor 230 are both outside the motor 210, so when the filter unit 220 is assembled on the motor 210, it is clearly to see the positions of the index mark 214 and the magnetic sensor 230. In this manner, it is unnecessary to additionally dispose a positioning mechanism, such as a positioning hole on the motor 210 and the filter unit 220, in other to finish the alignment of the index mark 214 and the filter unit 220. Therefore, the structures of the filter unit 220 and the motor 210 are simplified, and the production cost and the assembly complexity of the color wheel module 200 are reduced.

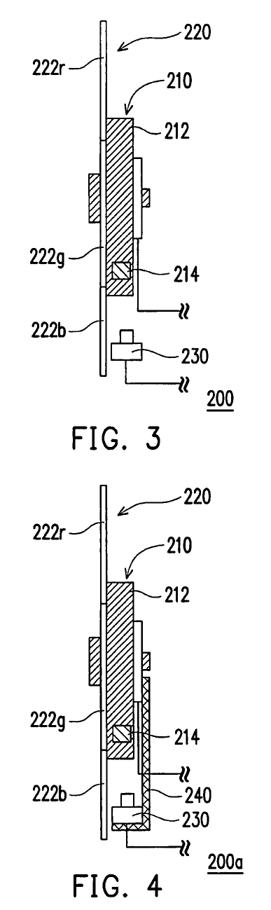

The magnetic sensor 230 may be directly fixed on a case of the projection apparatus 300 or on a fixing frame 240, as shown in the color wheel module 200a of FIG. 4. The fixing frame 240 is connected to the motor 210. Since the the fixing frame 240 is externally connected to the motor 210, the fixing frame 240 is easy to be disassembled. Therefore, when the motor 210 or the magnetic sensor 230 is damaged, it is only necessary to replace the damaged element.

To sum up, the embodiments of the present invention at least have one or a part of or all of the following advantages.

1. The magnetic sensor is disposed outside the motor, so when the motor or the magnetic sensor is damaged, it is only necessary to replace the damaged element. Thus, the maintenance cost is saved.

2. The index mark and the magnetic sensor are both outside the motor, and it is unnecessary to additionally dispose a positioning mechanism on the filter unit and the motor in other to finish the alignment of the filter unit and the index mark. Therefore, the structures of the filter unit and the motor are simplified, and the production cost and the assembly complexity of the color wheel module are reduced.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A color wheel module, comprising:
a motor having a rotating unit, wherein an index mark is disposed on the rotating unit;
a filter unit connected to the rotating unit; and
a magnetic sensor disposed adjacent to the motor, wherein the magnetic sensor is adopted for sensing the change of the magnetic field caused by the index mark rotating with the rotating unit.

2. The color wheel module as claimed in claim 1, wherein the index mark is a magnetic element disposed on the rotating unit.

3. The color wheel module as claimed in claim 1, wherein the index mark is a recess and a protrusion located on the rotating unit alternatively.

4. The color wheel module as claimed in claim 1, wherein the magnetic sensor is a Hall effect sensor.

5. The color wheel module as claimed in claim 1, further comprising a fixing frame connected to the motor, wherein the magnetic sensor is disposed on the fixing frame.

6. The color wheel module as claimed in claim 1, wherein the filter unit comprises a plurality of filters.

7. A projection apparatus, comprising:
a light source capable of providing an illumination beam;
a color wheel module disposed on a transmission path of the illumination beam, and comprising:
a motor having a rotating unit, wherein an index mark is disposed on the rotating unit;
a filter unit connected to the rotating unit; and
a magnetic sensor disposed adjacent to the motor, wherein the magnetic sensor is adopted for sensing the change of the magnetic field caused by the index mark rotating with the rotating unit and outputs a signal according to the rotation of the rotating unit;
a display element disposed on a transmission path of the illumination beam after passing through the color wheel module;
a control unit electrically connected to the motor, the magnetic sensor, and the display element, the control unit capable of driving the motor and controlling the display element to convert the illumination beam into an image beam according to a received image signal and the signal output by the magnetic sensor; and
a projection lens disposed on a transmission path of the image beam.

8. The projection apparatus as claimed in claim 7, wherein the index mark is a magnetic element disposed on the rotating unit.

9. The projection apparatus as claimed in claim 7, wherein the index mark is a recess or a protrusion located on the rotating unit.

10. The projection apparatus as claimed in claim 7, wherein the magnetic sensor is a Hall effect sensor.

11. The projection apparatus as claimed in claim 7, wherein the color wheel module further comprising a fixing frame connected to the motor, and the magnetic sensor is disposed on the fixing frame.

12. The projection apparatus as claimed in claim 7, wherein the filter unit comprises a plurality of filters.
